(19) United States
(12) Patent Application Publication
(10) Pub. No.: US 2008/0130966 A1
(43) Pub. Date: Jun. 5, 2008

(54) METHOD OF IMAGE ACQUISITION NOTIFICATION

(75) Inventor: Kevin M. CRUCS, Akron, OH (US)

Correspondence Address: HAHN LOESER & PARKS, LLP, One GOJO Plaza, Suite 300, AKRON, OH, 44311-1076, US

(73) Assignee: APTERYX, INC., Akron, OH (US)

(21) Appl. No.: 11/565,683

(22) Filed: Dec. 1, 2006

(51) Int. Cl. G06K 9/00

(52) U.S. Cl. 382/128

(57) ABSTRACT

A method of image acquisition notification is disclosed. A visual and/or audible indication is provided to a user of an application to indicate to the user that image acquisition has occurred. At least one digital image is acquired using an imaging modality and the image is automatically transmitted in an image acquisition notification message, via a network, in response to acquiring the at least one digital image. The image acquisition notification message is automatically received in an application running on a computer-based platform that is operationally connected to the network and is automatically displayed once received. A user of the application may select an iconic representation embedded within the displayed message to initiate displaying of the at least one acquired digital image associated with the notification message.

### TECHNICAL FIELD

Certain embodiments of the present invention relate to image acquisition and notification (e.g., in telemedicine). More particularly, certain embodiments of the present invention relate to a method of notifying a physician that acquired medical images are available.

### BACKGROUND OF THE INVENTION

In a typical medical environment, where a physician desires to have medical images taken of a patient, a worklist system (e.g., a DICOM compatible system) may be employed where the physician makes a request to a broker who then generates a request to an imaging modality technician (e.g., an X-ray technician). The technician queries the worklist system and receives the request. Initially, the status of the request is “to process”, for example. When the technician processes the request (i.e., acquires the images), the status of the request is changed to “processed”. The acquired images are typically archived, for example, on a PACS system.

The requesting physician may periodically check the archiving system to determine whether or not the requested images are available. This can be time-consuming and frustrating for the physician. Alternatively, a notification may be sent to the physician to make the physician aware that the images are available. This may help to prevent the physician from having to periodically check if the images are available. However, once notified, the physician may still have to go through the process of retrieving the images from an archiving system. In order to retrieve the images, the physician may need to become aware of specific codes, directories and/or or file names in order to access the images. Such a retrieving process by the physician can also be time-consuming and frustrating, for example, if the physician is given the wrong directory information, or if the physician incorrectly types in the information needed to access the images from the archive.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

In accordance with various embodiments of the present invention, a visual and/or audible indication is provided to a user of an application to indicate to the user that image acquisition has occurred.

An embodiment of the present invention provides a method of image acquisition notification. The method comprises acquiring at least one digital image using an imaging modality and automatically transmitting an image acquisition notification message, via a network, in response to acquiring the at least one digital image. The method also comprises automatically receiving the image acquisition notification message in an application running on a computer-based platform that is operationally connected to the network. The method further comprises automatically displaying the image acquisition notification message on a display of the computer-based platform in response to the receiving step. The method also comprises selecting an iconic representation embedded within the displayed image acquisition notification message to initiate displaying of the at least one acquired digital image associated with the notification message. The method further comprises automatically displaying the at least one acquired digital image on the display of the computer-based platform in response to the selecting step.

Another embodiment of the present invention provides a computer-readable medium having an application of computer-executable instructions for performing a method where the method comprises automatically receiving an image acquisition notification message, at a computer-based platform running said application of computer-executable instructions, which is automatically transmitted from an imaging modality system over a network in response to said imaging modality system acquiring at least on digital image. The method also comprises automatically displaying the image acquisition notification message, in response to the receiving step, on a display of the computer-based platform running the application of computer-executable instructions. The method further comprises allowing selecting of an iconic representation embedded within the displayed image acquisition notification message to initiate displaying of the at least one acquired digital image associated with the notification message. The method also comprises automatically displaying the at least one acquired digital image on the display of the computer-based platform in response to the selecting step.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a flowchart of an exemplary embodiment of a method of image acquisition notification, in accordance with various aspects of the present invention.

FIG. 2 is a schematic block diagram of an exemplary system for implementing the method of FIG. 1, in accordance with an embodiment of the present invention.

FIG. 3 illustrates a first exemplary embodiment of an image acquisition notification message being displayed in a window of an application on a display of the computer-based platform of FIG. 2 as part of the method of FIG. 1, in accordance with various aspects of the present invention.

FIG. 4 illustrates an exemplary embodiment of digital images of a patient being displayed on the display of the computer-based platform of FIG. 2 as part of the method of FIG. 1, in accordance with various aspects of the present invention.

FIG. 5 illustrates an exemplary embodiment of digital images of a patient being displayed on the display of the computer-based platform of FIG. 2 along with a dialogue box, in accordance with various aspects of the present invention.

FIG. 6 illustrates a single image, from the images of FIG. 4 or FIG. 5, being displayed on the display of the computer-based platform of FIG. 2, in accordance with various aspects of the present invention.

FIG. 7 illustrates a second exemplary embodiment of an image acquisition notification message being displayed in a window of an application on a display of the computer-based platform of FIG. 2 as part of the method of FIG. 1, in accordance with various aspects of the present invention.

FIG. 8 illustrates a functionality of an application to allow a user to drag and drop an image(s) into an electronic document in a document application window, in accordance with an embodiment of the present invention.

### DETAILED DESCRIPTION OF THE INVENTION

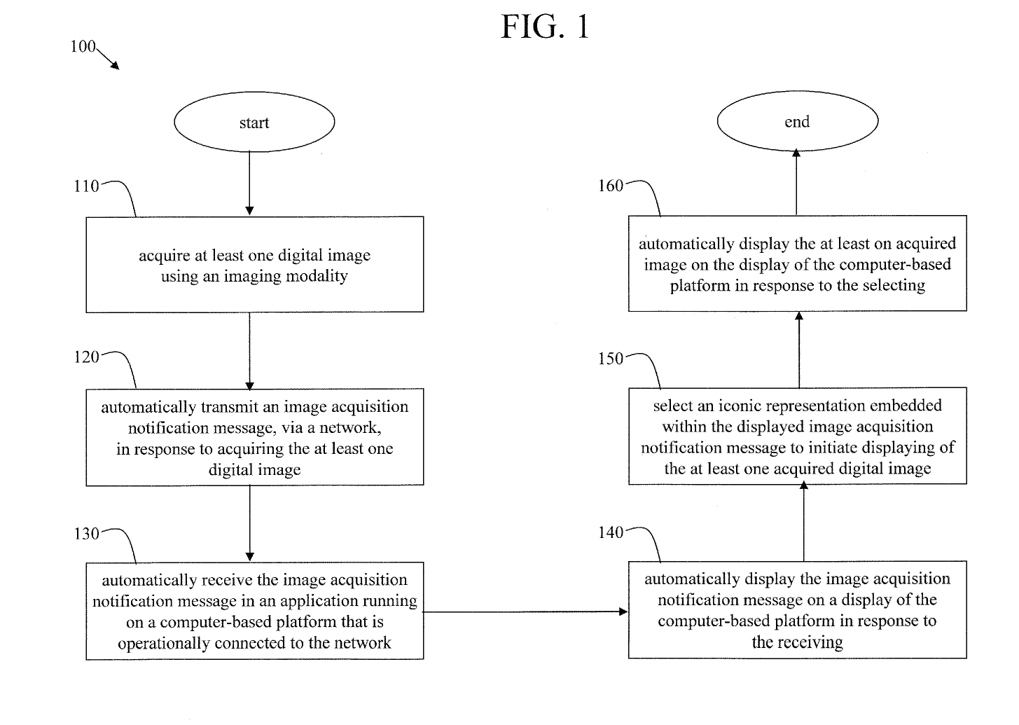

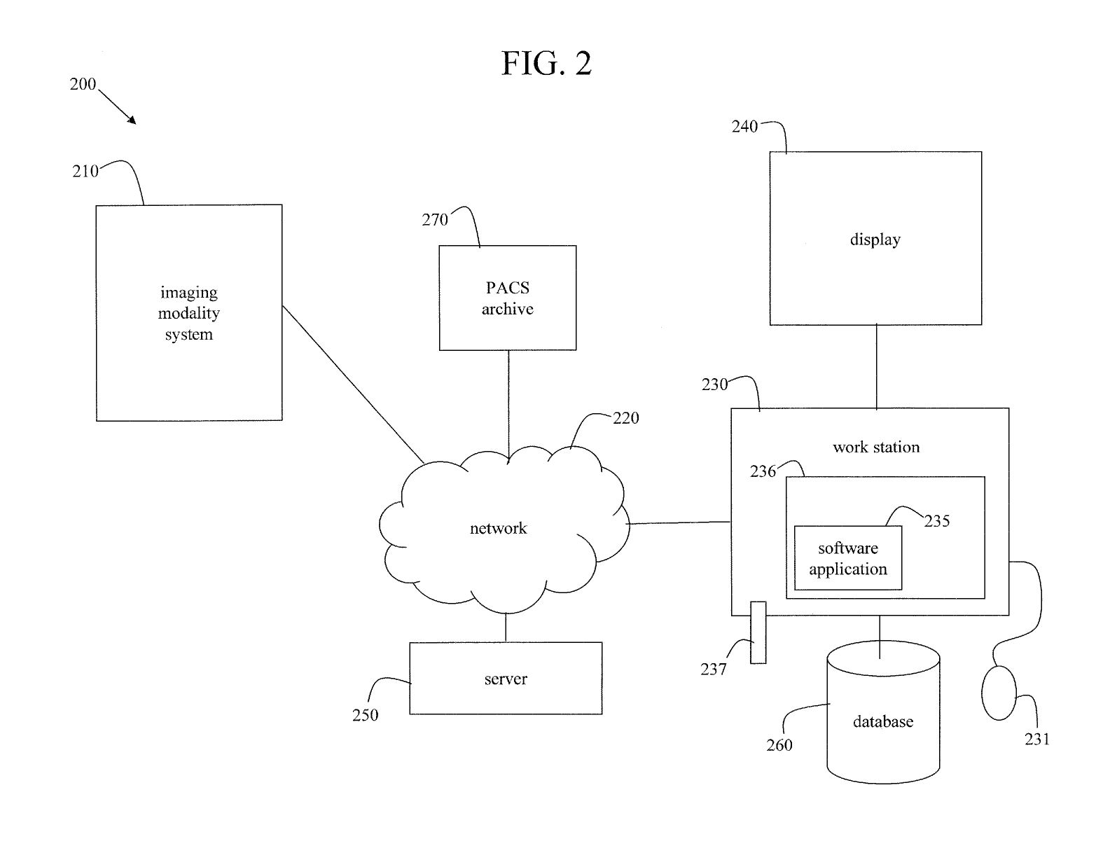

FIG. 1 is a flowchart of an exemplary embodiment of a method 100 of image acquisition notification, in accordance with various aspects of the present invention. FIG. 2 is a schematic block diagram of an exemplary system 200 for implementing the method 100 of FIG. 1, in accordance with an embodiment of the present invention.

In step 110 of the method 100, at least one digital image is acquired using an imaging modality. For example, the imaging modality may include any one of an X-ray imaging modality, an ultrasound imaging modality, an MR imaging modality, an optical imaging modality (e.g., using a camera), or any other type of imaging modality that uses an imaging system 210 to generate digital images (e.g., digital medical images using a medical imaging modality, or digital defect images of defects in manufactured or fabricated items).

In step 120, an image acquisition notification message is automatically transmitted, via a network 220, in response to acquiring the at least one digital image. In accordance with various embodiments of the present invention, the network 220 may comprise a wired communication network, a wireless communication network, or some combination thereof. The imaging modality system 210 is operationally connected to the network 220. In accordance with an embodiment of the present invention, the image acquisition notification message is transmitted over the network 220 in accordance with a DICOM (digital imaging and communications in medicine) standard protocol. In accordance with an alternative embodiment of the present invention, the image acquisition notification message is transmitted over the network 220 in accordance with a non-DICOM standard protocol.

In step 130, the image acquisition notification message is automatically received in an application 235 (i.e., a software application) running on a computer-based platform 230 that is operationally connected to the network 220. The computer-based platform 230 may be a personal computer (PC), a work station, a hand-held device, or any other processor-based device capable of performing the functions as described herein which are attributed to the computer-based platform 230. In accordance with an embodiment of present invention, the application 235 may be resident on a computer-readable medium 236 having the application 235 of computer-executable instructions for performing the methods described herein. The computer-readable medium 236 may comprise, for example, a hard drive, a compact disc (CD), a floppy disk, a digital video disc (DVD), or any other computer-readable medium.

In accordance with an embodiment of the present invention, the computer-based platform 230 and a user (e.g., a physician or a dentist) of the computer-based platform 230 are located remotely away from the imaging modality system 210. For example, the imaging modality system 210 and an X-ray technician using the imaging modality system 210 may be located in a hospital, and the work station 230 and physician using the work station 230 may be located miles away in a private doctor's office.

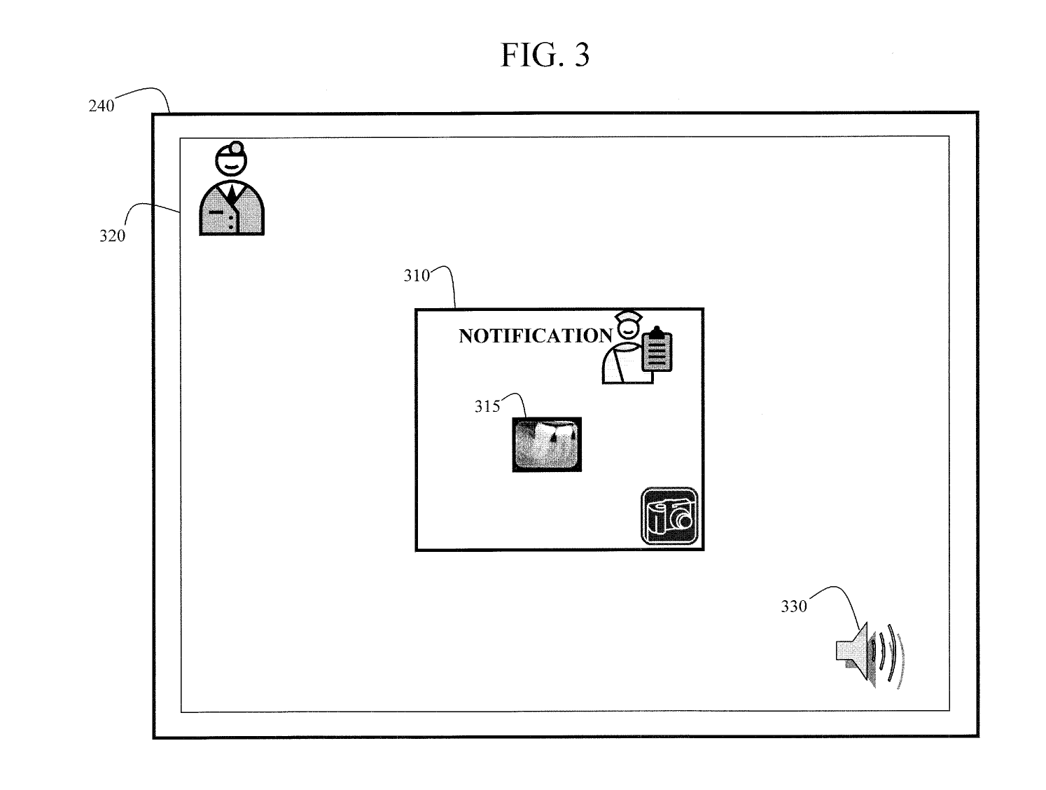

In step 140, the image acquisition notification message is automatically displayed on a display 240 of the computer-based platform 230 in response to the message being received by the application 235 running on the computer-based platform 230. FIG. 3 illustrates a first exemplary embodiment of an image acquisition notification message 310 being displayed in a window 320 of the application 235 on a display 240 of the computer-based platform 230 of FIG. 2 as part of the method 100 of FIG. 1, in accordance with various aspects of the present invention. In accordance with an embodiment of the present application, the image acquisition notification message 310 automatically “pops up” in a displayed window of the application 235 upon reception by the application 235 running on the computer-based platform 230. As an option, the application 235 may also trigger an audible sound 330 that is output by the computer-based platform 230 when the image acquisition notification message 310 “pops up” on the display 240. In accordance with an embodiment of the present invention, the image acquisition notification message 310 includes an iconic representation 315, which is displayed as part of the message 310, and an associated file or files.

In step 150, an iconic representation 315 embedded within the displayed image acquisition notification message 310 is selected (e.g., by a user of the application 235) to initiate displaying of the at least one acquired digital image associated with the notification message. In accordance with an embodiment of the present invention, the iconic representation 315 is an image thumbnail and is selected when a user “clicks” on the image thumbnail using a mouse 231 of the computer-based platform 230, for example.

The user may be, for example, a physician or a dentist. In accordance with an embodiment of the present invention, the user logs into the application 235 running on the computer-based platform 230 in order to access records of the patient. That is, only the particular user (e.g., physician) has permission to access the records of a particular patient. The image acquisition notification message 310 is associated with the user such that only the user, when logged into the application 235, may access the image acquisition notification message 310 for the user's patient. For example, only the permitted user can select the iconic representation 315 to open the file. Also, for example, before acquiring the images with the imaging modality system 210, an X-ray technician may designate an individual (e.g., the patient's physician or dentist) such that only the designated individual can receive the image acquisition notification message 310 when logged into the application 235.

In accordance with an embodiment of the present invention, the image acquisition notification message 310 is displayed on the display 240 of the computer-based platform 230 only when the permitted user is logged into the application 235. In accordance with an alternative embodiment of the present application, the image acquisition notification message 310 is displayed on the display 240 of the computer-based platform 230 no matter who is logged into the application 235. However, only a designated or permitted user (e.g., the dentist of the patient associated with the message 310) may be able to access the message 310.

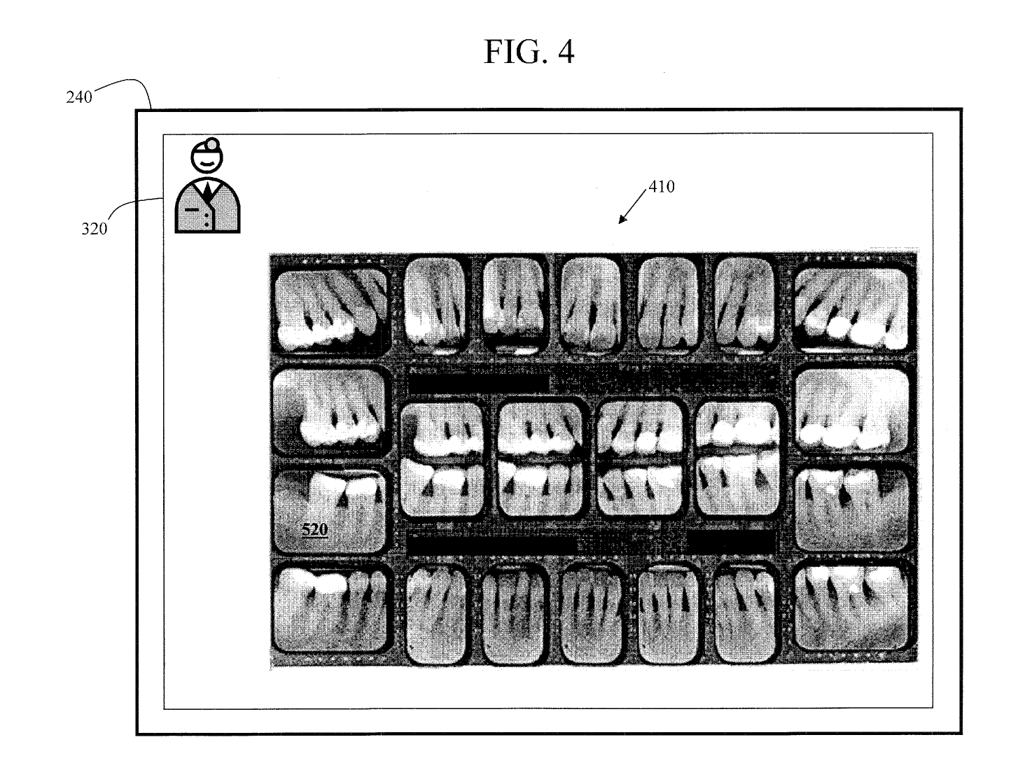

In step 160, the at least one acquired image is automatically displayed on the display 240 of the computer-based platform 230 in response to selecting the iconic representation 315. The user may then observe the image (or images) on the display 240. FIG. 4 illustrates an exemplary embodiment of digital images 410 of a patient being displayed on the display 240 of the computer-based platform 230 of FIG. 2 as part of the method 100 of FIG. 1, in accordance with various aspects of the present invention. The images 410 may include a set of dental X-ray images or any other type of images, in accordance with various embodiments of the present invention (e.g., other types of medical images or fabrication images).

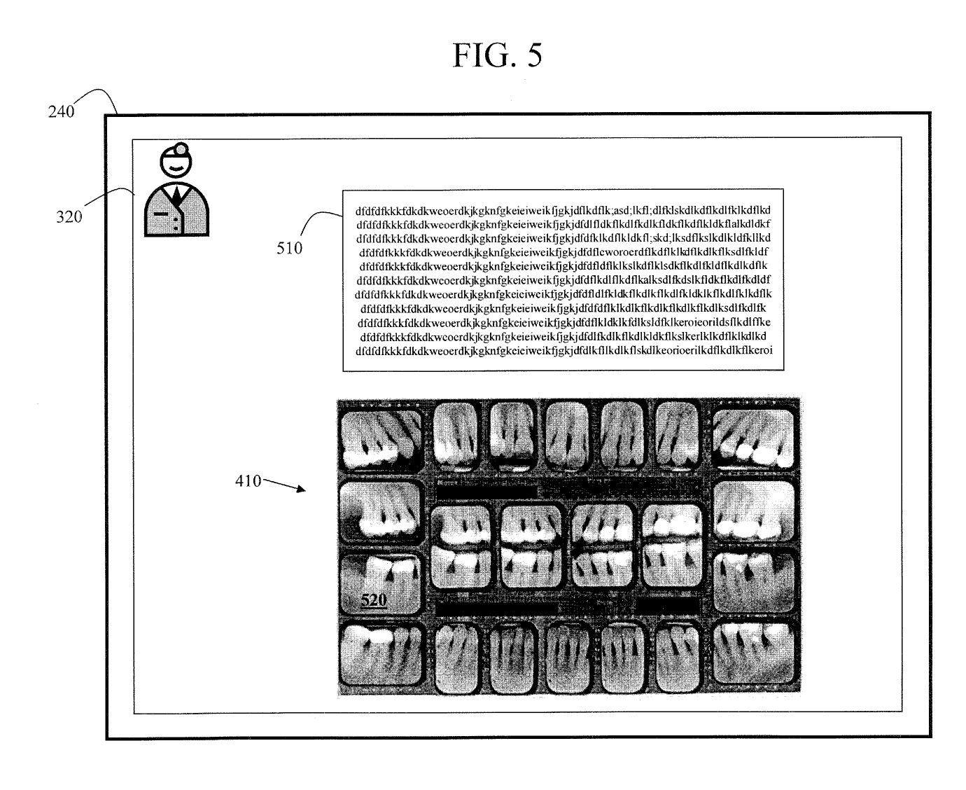

FIG. 5 illustrates an exemplary embodiment of digital images 410 of a patient being displayed on the display 240 of the computer-based platform 230 of FIG. 2 along with a dialogue box 510, in accordance with various aspects of the present invention. The dialogue box 510 may contain identifying information such as patient information, doctor information (e.g., name and number), and/or comments from a technician who acquired the images 410 using an imaging modality system 210. Both the images 410 and the dialogue box 510 are displayed in response to a user selecting the iconic representation 315, in accordance with an embodiment of the present invention.

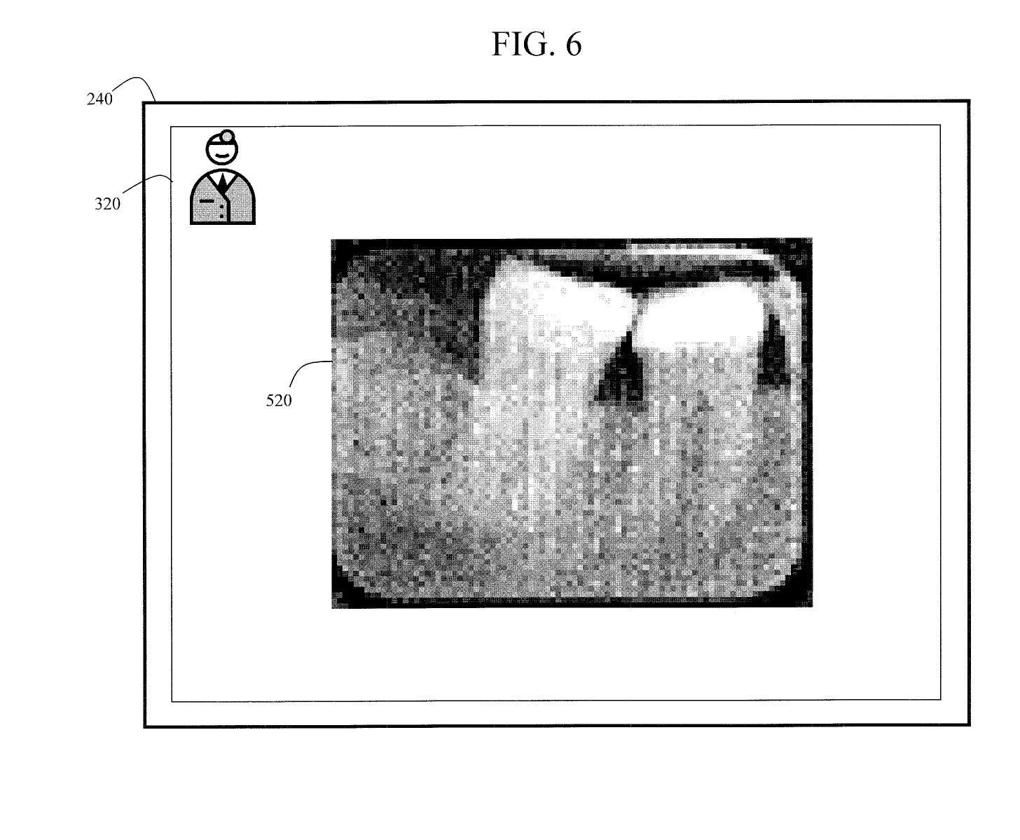

FIG. 6 illustrates a single image 520, from the images 410 of FIG. 4 or FIG. 5, being displayed on the display 240 of the computer-based platform 230 of FIG. 2, in accordance with various aspects of the present invention. When the user is viewing the set of images 410, the user may select (e.g., by clicking with a mouse) any one of the images (e.g., image 520) and view that image 520. The image 520 is displayed on the display 240 in the window 320 of the application 235 such that the image 520 is “blown up” or “enlarged” for better viewing by the user (e.g., by a dentist).

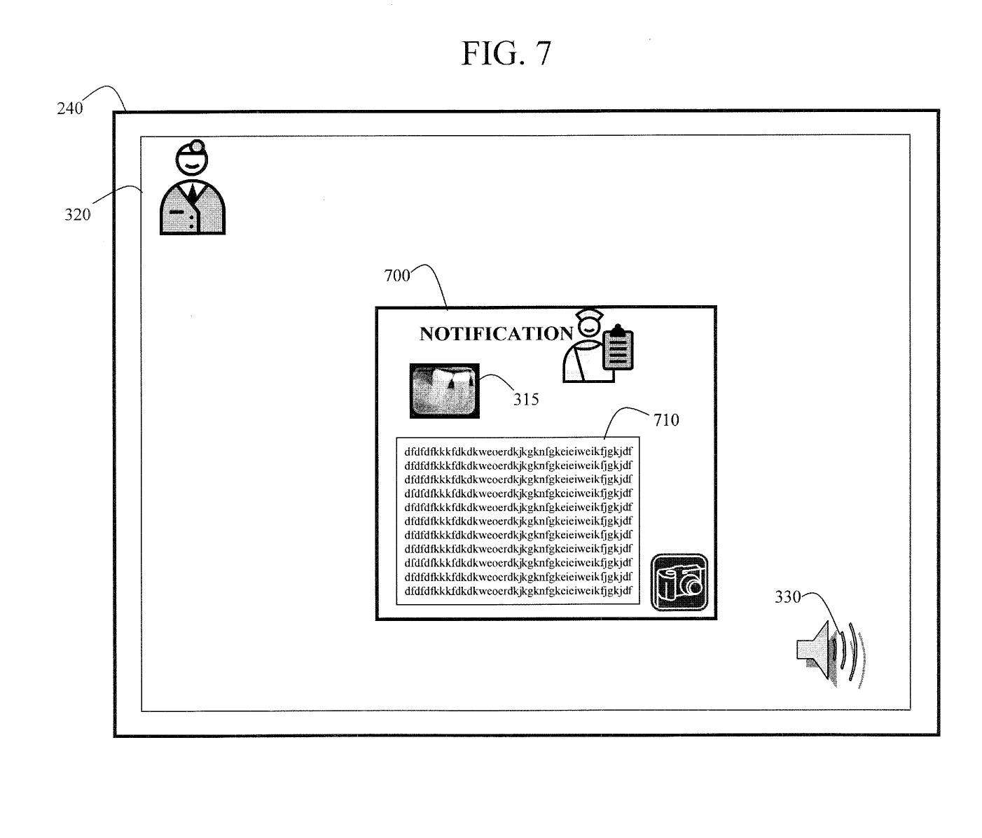

FIG. 7 illustrates a second exemplary embodiment of an image acquisition notification message 700 being displayed in a window 320 of the application 235 on a display 240 of the computer-based platform 230 of FIG. 2 as part of the method 100 of FIG. 1, in accordance with various aspects of the present invention. The displayed notification message 700 includes an iconic representation 315 as well as a dialogue box 710. Again, the dialogue box 710 may contain identifying information and/or comments from a technician who acquired the images 410 using an imaging modality system 210.

In accordance with an embodiment of the present invention, the digital image (or images) received in the image acquisition notification message 310 may be saved by the user of the computer-based platform 230. For example, the user may save the digital image(s) as files to a storage device of the computer-based platform 230 such as a hard disk 236, a memory stick 237, or some other digital storage device (e.g., a CD or DVD), using the application 235 running on the computer-based platform 230.

In accordance with another embodiment of the present invention, the digital image(s) may be saved as files by the user to a server 250 operationally connected to the computer-based platform 230 or to the network 220, using the application 235 running on the computer-based platform 230. In accordance with still another embodiment of the present invention, the digital image(s) may be saved by the user to a database 260 operationally connected to the computer-based platform 230 or to the network 220, using the application 235 running on the computer-based platform 230. In accordance with yet another embodiment of the present invention, the digital image(s) may be saved by the user to an archiving device 270 (e.g., a PACS archiving system) operationally connected to the computer-based platform 230 or to the network 220, using the application 235 running on the computer-based platform 230. Just as images may be saved, as described above herein, images may also be deleted, in a similar but opposite manner by the user.

Similarly, the image acquisition notification message itself, with all of its constituent parts (e.g., image thumbnail, image file or image object, dialogue box, etc.), may be saved or deleted just as images may be saved or deleted.

Again, all of the functionality of the application 235 as described herein may be resident on a computer-readable medium having computer-executable instructions that provide the functionality when executed on a computer-based platform 230. For example, an embodiment of the present invention comprises a computer-readable medium having an application of computer-executable instructions for performing a method comprising automatically receiving an image acquisition notification message, at a computer-based platform running the application of computer-executable instructions, which is automatically transmitted from an imaging modality system over a network in response to the imaging modality system acquiring at least one digital image; automatically displaying the image acquisition notification message, in response to the receiving, on a display of the computer-based platform running the application of computer-executable instructions; allowing selecting of an iconic representation embedded within the displayed image acquisition notification message to initiate displaying of the at least one acquired digital image associated with the notification message, and automatically displaying the at least one acquired digital image on the display of the computer-based platform in response to the selecting. The receiving may be performed in accordance with a DICOM standard protocol, or a non-DICOM protocol, for example.

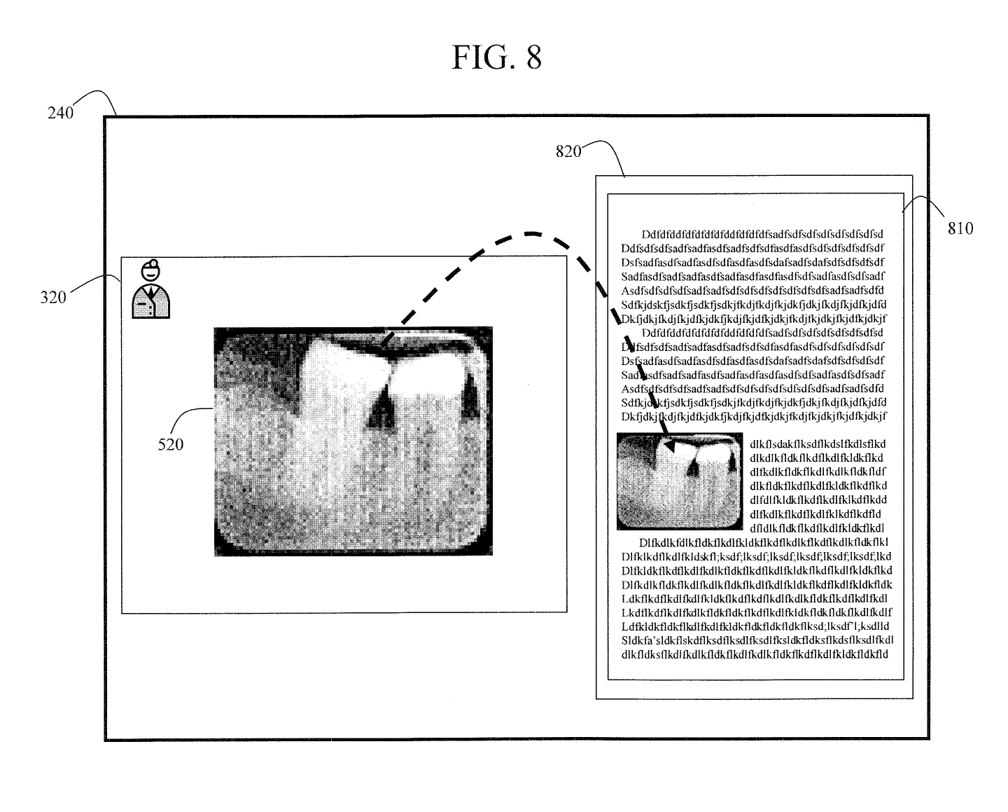

FIG. 8 illustrates a functionality of the application 235 to allow a user to drag and drop an image(s) 520 into an electronic document 810 in a document application window 820, in accordance with an embodiment of the present invention. The document application corresponding to the document application window 820 is an entirely separate application from that of the application 235, in accordance with an embodiment of the present invention. However, both the application 235 and the document application run on the computer-based platform 230 wherein the document application window 820 is compatible with the application 235 such that an image(s) may be dragged from the window 320 and dropped at a location within a document 810 in the document application window 820. In accordance with an alternative embodiment of the present invention, the document application window 820 may be a part of the application 235. That is, a user is able to generate documents using the application 235 and drag and drop images into the documents as described above herein.

In summary, embodiments of the present invention provide a software application having computer-executable instructions for performing a method of image acquisition notification. An image acquisition notification message is automatically sent to a designated user (e.g., a physician or a dentist) providing a visual and/or audible indication to the user such that the user may immediately access the acquired image(s). The software application may be resident on a computer-readable medium.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of image acquisition notification, said method comprising:
acquiring at least one digital image using an imaging modality;
automatically transmitting an image acquisition notification message, via a network, in response to acquiring said at least one digital image;
automatically receiving said image acquisition notification message in an application running on a computer-based platform that is operationally connected to said network;
automatically displaying said image acquisition notification message on a display of said computer-based platform in response to said receiving;
selecting an iconic representation embedded within said displayed image acquisition notification message to initiate displaying of said at least one acquired digital image associated with said notification message; and
automatically displaying said at least one acquired digital image on said display of said computer-based platform in response to said selecting.

2. The method of claim 1 wherein said imaging modality comprises a medical imaging modality and said at least one digital image comprises a medical image acquired from a patient.

3. The method of claim 1 wherein said network comprises a wireless network.

4. The method of claim 1 wherein said network comprises a wired network.

5. The method of claim 1 wherein said image acquisition notification message is displayed by popping up in a displayed window of said application.

6. The method of claim 1 wherein said iconic representation comprises an image thumbnail.

7. The method of claim 2 further comprising automatically displaying a dialogue box containing identifying information as part of displaying said image acquisition notification message.

8. The method of claim 2 further comprising automatically displaying patient information on said display of said computer-based platform in response to said selecting.

9. The method of claim 1 wherein said selecting comprising clicking on said iconic representation using a mouse of said computer-based platform.

10. The method of claim 1 further comprising said computer-based platform outputting an audible sound in response to displaying said image acquisition notification message.

11. The method of claim 2 further comprising a physician, having permission to access records of said patient, logging into said application on said computer-based platform.

12. The method of claim 11 wherein said image acquisition notification message is displayed on said display of said computer-based platform only when said permitted physician is logged into said application.

13. The method of claim 11 wherein said image acquisition notification message is displayed on said display of said computer-based platform no matter who is logged into said application.

14. The method of claim 11 wherein only said permitted physician can select said iconic representation to open said file.

15. The method of claim 11 wherein said physician is remotely located away from a location where said at least one image is acquired.

16. The method of claim 1 further comprising designating an individual before acquiring said at least one digital image such that only said designated individual can receive said image acquisition notification message when logged into said application.

17. The method of claim 1 wherein said image acquisition notification message is transmitted over said network in accordance with a DICOM standard protocol.

18. The method of claim 1 wherein said image acquisition notification message is transmitted over said network in accordance with a non-DICOM protocol.

19. The method of claim 1 further comprising saving said at least one digital image to a storage device of said computer-based platform using said application.

20. The method of claim 1 further comprising saving said at least one digital image to a server operationally connected to said computer-based platform using said application on said computer-based platform.

21. The method of claim 1 further comprising saving said at least one digital image to a database operationally connected to said computer-based platform using said application on said computer-based platform.

22. The method of claim 1 further comprising archiving said at least one digital image to an archiving device operationally connected to said computer-based platform using said application on said computer-based platform.

23. The method of claim 1 further comprising dragging and dropping said at least one digital image into an electronic document using said application on said computer-based platform.

24. The method of claim 1 further comprising deleting said at least one digital image.

25. The method of claim 1 further comprising deleting said image acquisition notification message.

26. The method of claim 1 further comprising saving said image acquisition notification message to a storage device of said computer-based platform using said application.

27. A computer-readable medium having an application of computer-executable instructions for performing a method comprising:
automatically receiving an image acquisition notification message, at a computer-based platform running said application of computer-executable instructions, which is automatically transmitted from an imaging modality system over a network in response to said imaging modality system acquiring at least one digital image;
automatically displaying said image acquisition notification message, in response to said receiving, on a display of said computer-based platform running said application of computer-executable instructions;
allowing selecting of an iconic representation embedded within said displayed image acquisition notification message to initiate displaying of said at least one acquired digital image associated with said notification message; and
automatically displaying said at least one acquired digital image on said display of said computer-based platform in response to said selecting.

28. The computer-readable medium of claim 27 where said imaging modality comprises a medical imaging modality and said at least one digital image comprises a medical image acquired from a patient.

29. The computer-readable medium of claim 27 where said image acquisition notification message is displayed by popping up in a displayed window provided by said application.

30. The computer-readable medium of claim 27 where said iconic representation comprises an image thumbnail.

31. The computer-readable medium of claim 28 where said method further comprises automatically displaying a dialogue box containing identifying information as part of displaying said image acquisition notification message.

32. The computer-readable medium of claim 28 where said method further comprises automatically displaying patient information on said display of said computer-based platform in response to said selecting.

33. The computer-readable medium of claim 27 where said selecting comprises a user clicking on said iconic representation using a mouse of said computer-based platform.

34. The computer-readable medium of claim 27 where said method further comprises triggering an audible sound to be output by said computer-based platform in response to displaying said image acquisition notification message.

35. The computer-readable medium of claim 28 where said method further comprises allowing a physician, having permission to access records of said patient, to log into said application running on said computer-based platform.

36. The computer-readable medium of claim 35 where said image acquisition notification message is displayed on said display of said computer-based platform only when said permitted physician is logged into said application.

37. The computer-readable medium of claim 35 where said image acquisition notification message is displayed on said display of said computer-based platform no matter who is logged into said application.

38. The computer-readable medium of claim 35 where only said logged-in permitted physician can select said iconic representation to open said file.

39. The computer-readable medium of claim 27 where said receiving is performed in accordance with a DICOM standard protocol.

40. The computer-readable medium of claim 27 where said receiving is performed in accordance with a non-DICOM protocol.

41. The computer-readable medium of claim 27 where said method further comprises saving said at least one digital image to a storage device of said computer-based platform.

42. The computer-readable medium of claim 27 where said method further comprises saving said at least one digital image to a server operationally connected to said computer-based platform.

43. The computer-readable medium of claim 27 where said method further comprises saving said at least one digital image to an archiving device operationally connected to said computer-based platform.

44. The computer-readable medium of claim 27 where said method further comprises dragging and dropping said at least one digital image into an electronic document.

45. The computer-readable medium of claim 27 where said method further comprises deleting said at least one digital image.

46. The computer-readable medium of claim 27 where said method further comprises deleting said image acquisition notification message.

47. The computer-readable medium of claim 27 where said method further comprises saving said image acquisition notification message to a storage device of said computer-based platform.
